(19) United States
(12) Patent Application Publication
(10) Pub. No.: US 2007/0226478 A1
(43) Pub. Date: Sep. 27, 2007

(54) Secure boot from secure non-volatile memory

(76) Inventor: John Rudelic, Folsom, CA (US)

Correspondence Address: INTEL CORPORATION;c/o INTELLEVATE, LLC, P.O. BOX 52050, MINNEAPOLIS, MN, 55402, US

(21) Appl. No.: 11/388,323

(22) Filed: Mar. 23, 2006

(51) Int. Cl. G06F 15/177

(52) U.S. Cl. 713/1

(57) ABSTRACT

In various embodiments, boot code in a computer system may make itself inaccessible after completing its boot operations, thus preventing it from being modified by unauthorized code subsequent to the boot operation. In some embodiments, this inaccessibility may make itself unreadable, so that it cannot be read and analyzed by unauthorized code. One or more specific startup triggers, such as a system reset, may make the boot code accessible again so that it can perform its boot operations before making itself inaccessible again.

### BACKGROUND

With the prevalence of computer viruses, worms, etc., that disrupt normal computer operations and even destroy code and/or data, security software has been developed to protect against such attacks. Some of the underlying security protections may be placed in the boot code, which can be used to verify the integrity of the other software as that other software is loaded, and can also verify the integrity of monitoring software that can monitor applications software as it is run. The boot code may only be used upon startup, and therefore is less likely to be corrupted during operation. However, under certain conditions the boot code can be modified by malware or other hostile code after the boot operation is complete, and those protections can therefore be disabled so that the integrity of the other software is not adequately checked upon the next startup, and is not adequately monitored during subsequent operation. This in turn allows that other software to be corrupted.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a flow diagram of a method of protecting boot code, according to an embodiment of the invention.

FIG. 2 shows a series of operations in a memory, according to an embodiment of the invention.

FIG. 3 shows a system, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

As used herein, unless otherwise specified the use of the ordinal adjectives “first”, “second”, “third”, etc., to describe a common object, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to electromagnetic, optical, or acoustical carrier wave signals.

Various embodiments of the invention may pertain to a technique for starting a computer system using boot code that makes itself inaccessible after its intended boot operations are complete, thus preventing it from being modified, and in some embodiments may make it unreadable so that the boot code cannot be analyzed through unauthorized activities. After the boot code makes itself inaccessible, in some embodiments only a system reset, such as may be generated by a power-on, hard reset, or in some cases a system restart, may make the boot code accessible again. As used herein, a system reset is a reset operation and/or reset signal that causes the boot code to be executed.

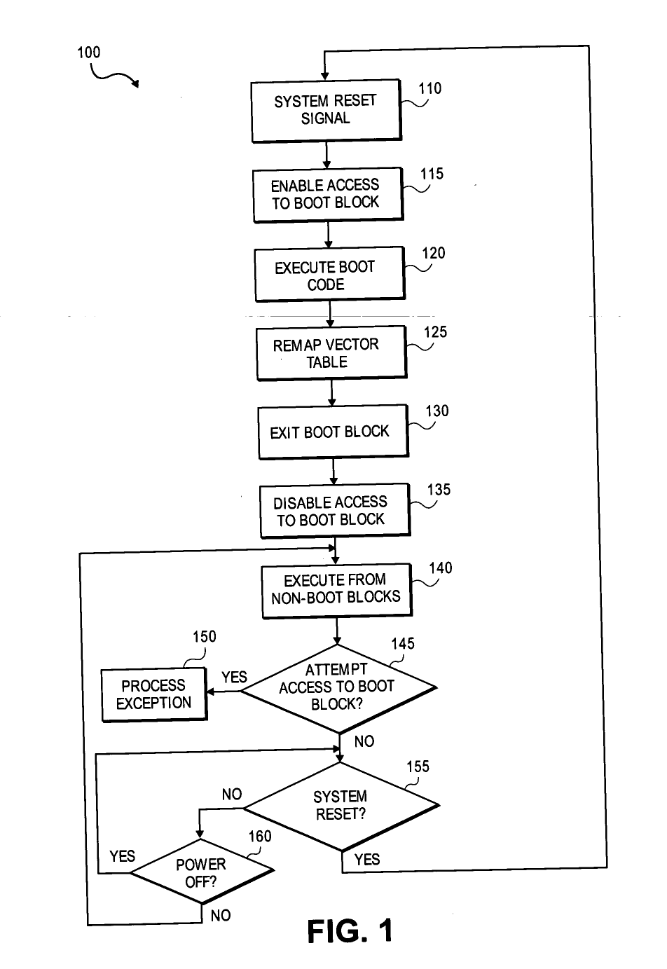

FIG. 1 shows a flow diagram of a method of protecting boot code, according to an embodiment of the invention. In flow diagram 100, at 110 a system reset signal may enable boot code to be accessible at 115. After enabling access to the boot code at 115, the boot code may be executed at 120. In some embodiments, the boot code may perform various operations, such as but not limited to: 1) providing a vector table to redirect interrupts to interrupt handling code at the appropriate addresses; 2) determining various hardware and/or software configurations that currently exist in the system (note: as used herein, the term ‘software’ also includes firmware, i.e., it makes no difference whether the code is located in volatile or non-volatile storage); 3) validating various hardware and/or software in the system to verify that they are the correct and/or authorized versions; 4) performing memory integrity checks to identify faulty memory locations; 5) allocating system memory to various functions, 6) enabling and/or setting hardware configurations, 7) etc.

Once the boot code has finished its operations, it may prepare to redirect execution to areas external to the boot code. At 125, the vector table may be remapped to areas that are outside the boot code, so that interrupts and/or other functions that use the vector tables will not have to access the boot code area any more. At 130, execution may be transferred to a portion of memory that is external to the memory address range containing the boot code. Note: the text in FIG. 1 refers to a boot ‘block’ rather than boot ‘code’. This refers to the use of memory blocks in flash memory, which is a common technology for non-volatile memory. Flash memory blocks, in defined sizes, may be disabled, enabled, erased, etc. in one-block increments. However, it is understood that the term ‘block’, as used herein, is merely an example of what type of memory increments may be disabled and/or enabled. Other technologies, and the terminology used to describe the relevant increments of those memories, are considered to be within the scope of various embodiments of the invention.

At 135, further access to the boot block may be disabled. In some embodiments, disabling the boot block may be triggered by execution of one or more particular instructions that are designed for that purpose. In one embodiment, a memory controller that controls access to the memory may set one or more hardware bits to prevent further access to the memory addresses that contain the boot code. Preventing access may include preventing write access, or preventing both read and write access, or preventing read access if write access is already prevented such as in a read-only memory. A flash memory controller, which may typically be contained within the same integrated circuit that contains the flash memory array, may perform this operation by preventing further access to the flash block(s) that contain the boot code. Other embodiments may use other techniques, such as but not limited to: 1) turning off power to the relevant portion of the memory; 2) disabling control and/or data and/or address lines to the relevant portions of the memory; 3) remapping address lines to the relevant block of addresses, 4) etc. Whichever technique is used, the denied access may not be directly restored simply by executing code that is external to the restricted memory area.

After disabling the boot code, execution may continue from non-boot memory areas at 140. Such execution may include execution of the operating system, application programs, processes, post-boot interrupt handlers, etc. This non-boot execution may continue as long as the system continues to operate, including continuing during and/or after various low power modes. If the continued code execution attempts to access the disabled portion of the non-volatile memory, as determined at 145, this may represent an attempted violation of the intended purpose of disabling the boot code and should not be permitted to successfully access the disabled portion of memory. As a result of the attempted violation, this exception to authorized operation may be handled at 150 by exception processing. Depending on the nature of that exception processing, various things may happen, such as but not limited to: 1) displaying a warning on the system display, 2) sending a warning message over a network, 3) logging the exception in a history file, 4) shutting down the system, 5) etc. Another thing that may happen during system operation is a system reset, which may be triggered by various causes and detected at 155. In such a case, a system reset signal may be generated at 110, which may cause the system to re-boot as previously described. Another action may be a system power down, as detected at 160. When the system is powered down, no further processing may take place, but a subsequent power-on reset will trigger the aforementioned system reset signal at 110, which may, cause the system to re-boot as previously described.

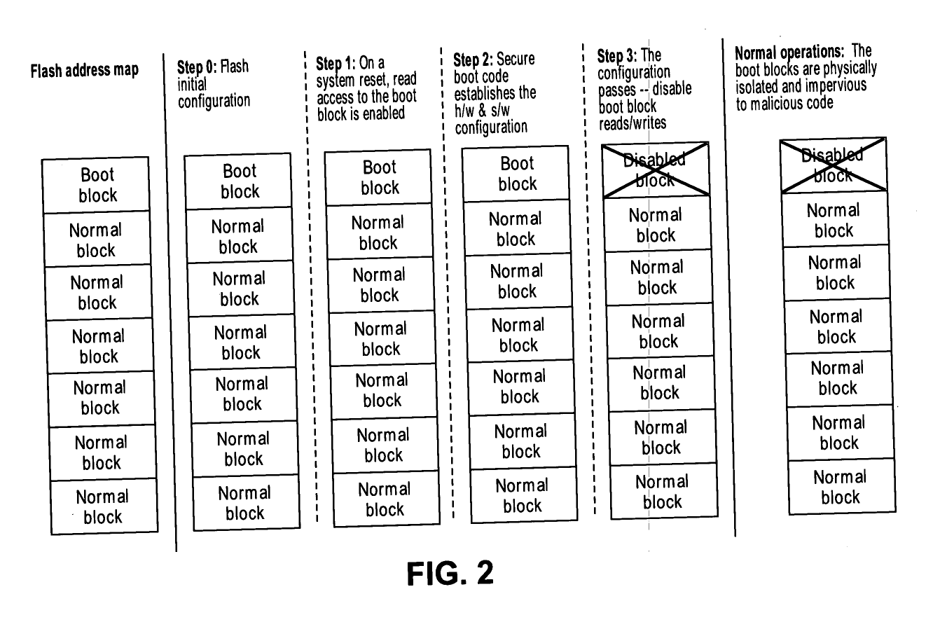

FIG. 2 shows a series of operations in a memory, according to an embodiment of the invention. Each column in FIG. 2 illustrates the same group of memory blocks, at different operational stages. The first column shows a typical flash address map, with a boot block at one end of the address range (it could be anywhere in the available address range, though the low end starting with address 0000 may be more common). The remaining memory address range is shown divided into multiple normal blocks, with the term ‘normal’ in this case indicating only that they are not boot blocks. The illustration indicates the memory is a flash memory, which is divided into blocks, which is common with flash memory. However, various embodiments of the invention are not limited to this, and may be implemented in other types of memory. Any technique and terminology for dividing the memory address range into smaller quantifiable address ranges may be used, such as pages, sections, etc., rather than blocks. Further, although the boot code should reside in non-volatile memory (such as but not limited to flash memory, phase change memory, ferromagnetic memory, etc.), the remaining memory may be volatile and/or non-volatile memory of any feasible type (such as but not limited to the aforementioned non-volatile memories, static random access memory, dynamic random access memory, etc.). In addition, the boot code may be large enough to require multiple blocks (pages, sections, etc.), although only one block is shown. As long as the boot block(s)/page(s)/section(s), etc. may be disabled without disabling the remaining blocks/pages/sections/etc., then the inventive concepts may be applied to any feasible type of memory. However, for simplicity of explanation, the remaining description will use flash memory and blocks as an example for the entire system memory (such as might be used in a cell phone, for example), with a single boot block.

In the column labeled Step 0, the flash memory may be in some initial configuration, which is undefined in this example. At Step 1, a system reset may enable access to the boot block and cause a processor to begin reading and executing the contents of the boot block, as well as enable initial vector tables to be accessible so that hard-wired access (such as interrupt vectors) may be directed to the correct locations. In some embodiments, only read access is enabled (assuming write access is never enabled), but in other embodiments only write access is enabled (assuming read access is never disabled), while in still other embodiments both read and write access to the boot block may be enabled, allowing the code in the boot block to modify the contents of the boot block (for example, to store parameters that are determined during the boot process and are temporarily needed during the boot process).

At Step 2, execution of the boot code may establish various hardware and/or software configuration parameters, which may then be stored external to the boot block. Once the boot process has been completed and any validations have been successful, execution may be transferred to one of the normal blocks at Step 3, after disabling the boot block to further access by the processor or other device. This disabled status for the boot block may then continue while normal operations are performed by executing code in the normal blocks. Since access to the boot block is now disabled, malicious code executed during the normal operations cannot alter the boot block and thereby permanently alter the secure boot process. The boot block may stay in this disabled state until another system reset returns the process to Step 1.

The embodiments described herein may not be able to prevent all malicious code from causing detrimental effects to the system during normal operations. Other security measures may be taken to defend against such attacks. However, even if such malicious attacks are successful, a re-boot of the system may at least restore the system to a pre-defined state due to the fact that the boot code has been protected from alteration.

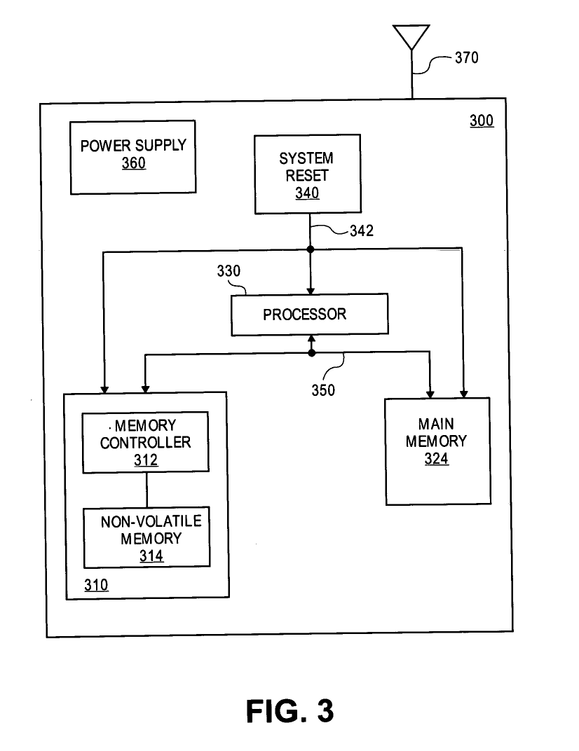

FIG. 3 shows a system, according to an embodiment of the invention. In system 300, a processor 330 may be coupled to various memory types over one or more memory buses 350. By way of example, the figure shows a non-volatile memory device 310 comprising a controller 312 for controlling a non-volatile memory array 314, as well as a separate main memory 324 (which may be volatile and/or non-volatile memory) controlled by a separate controller (not shown). In this embodiment, the boot block may be contained within non-volatile memory array 314, with the previously described normal memory areas in main memory 324. In other embodiments, main memory may not be separate, but may be included in the non-volatile memory array 314. In still other embodiments, normal memory may be distributed between non-volatile memory array 314 and a volatile memory. In some embodiments, memory controller 312 and non-volatile memory array 314 may be located in a single integrated circuit. In various embodiments, the system 300 may also contain other components, such as an antenna 370 for wireless communications and/or a power supply 360. The power supply 360 may be a plug-in power supply or a self-contained power supply such as a battery.

Regardless of the memory configuration used, reset circuitry 340 may generate a reset signal over a reset line 342 (possibly including reset distribution logic, not shown) whenever a system reset condition is created. This reset signal may be routed to the various parts of the system that use it, including the non-volatile memory controller 312, which may in turn enable access to the boot block within non-volatile memory array 314 before beginning the boot process.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising:
a non-volatile memory comprising boot code, the boot code containing instructions to perform a boot operation and containing at least one instruction to subsequently disable access to the boot code;
wherein the non-volatile memory is configured to re-enable access to the boot code only by a system reset.

2. The apparatus of claim 1, wherein the system reset is to be initiated by a power-up operation.

3. The apparatus of claim 1, wherein the system reset is to be initiated by a hard reset.

4. The apparatus of claim 1, wherein the boot operation comprises at least one of:
a determination of a hardware configuration;
a validation of a hardware configuration;
a determination of a software configuration; and
a validation of a software configuration.

5. The apparatus of claim 1, wherein said disabling access comprises disabling access to a range of addressable memory locations containing the boot code.

6. The apparatus of claim 5, further comprising instructions to remap access to a vector table subsequent to performing the boot operation.

7. The apparatus of claim 1, further comprising a memory controller configured to perform said disabling.

8. The apparatus of claim 7, wherein the memory controller is in a same integrated circuit as a portion of the non-volatile memory containing the boot code.

9. The apparatus of claim 1, wherein the at least one instruction to disable access is configured to disable both read and write access to the boot code.

10. A system, comprising:
at least one component selected from a list consisting of a battery and an antenna;
a processor coupled to the at least one component, and
a non-volatile memory coupled to the processor and comprising boot code, the boot code containing instructions to be executed by the processor to perform a boot operation and containing at least one instruction to disable access to a portion of the non-volatile memory containing the boot code;
wherein the non-volatile memory is configured to re-enable access to the boot code only by a system reset.

11. The system of claim 10, wherein the system reset is to be initiated by a power-up operation.

12. The system of claim 10, wherein the boot operation comprises at least one of:
a determination of a hardware configuration;
a validation of a hardware configuration;
a determination of a software configuration; and
a validation of a software configuration.

13. The system of claim 10, further comprising instructions to remap access to a vector table subsequent to said performing the boot operation.

14. The system of claim 10, further comprising a memory controller configured to perform said disabling.

15. A method, comprising:
executing boot code to perform a boot operation;
subsequently disabling access to the boot code and continuing execution in code external to the boot code; and
re-enabling access to the boot code only by a system reset.

16. The method of claim 15, wherein said executing boot code comprises executing code to perform at least one of:
determining a hardware configuration;
validating the hardware configuration;
determining a software configuration; and
validating the software configuration.

17. The method of claim 15, wherein said disabling access comprises operating a memory controller to identify a portion of the non-volatile memory as not accessible by a processor.

18. The method of claim 15, further comprising remapping access to a vector table subsequent to said executing boot code and prior to said re-enabling.

19. An article comprising
a tangible machine-readable medium that contains instructions, which when executed by one or more processors result in performing operations comprising:
executing boot code to perform a boot operation;
subsequently disabling access to the boot code and continuing execution of code external to the boot code; and
re-enabling access to the boot code only by a system reset.

20. The article of claim 19, wherein the operation of executing boot code comprises executing code to perform at least one of:
determining a hardware configuration;
validating the hardware configuration;
determining a software configuration; and
validating the software configuration.

21. The article of claim 19, wherein the operation of disabling access comprises operating a memory controller to identify a portion of the non-volatile memory as inaccessible.

22. The article of claim 19, wherein the operations further comprise remapping access to a vector table subsequent to said executing the boot code.
